(19) United States
(12) Patent Application Publication
(10) Pub. No.: US 2010/0232887 A1
(43) Pub. Date: Sep. 16, 2010

(54) BREAKAWAY CASING CONNECTION

(75) Inventors: Robert L. Parsons, Lawrence, KS (US); M. Luke Schuler, Shawnee Mission, KS (US)

Correspondence Address: Workman Nydegger;1000 Eagle Gate Tower, 60 East South Temple, Salt Lake City, UT, 84111, US

(73) Assignee: UNIVERSITY OF KANSAS, Lawrence, KS (US)

(21) Appl. No.: 12/723,979

(22) Filed: Mar. 15, 2010

Related U.S. Application Data
(60) Provisional application No. 61/160,178, filed on Mar. 13, 2009.

(51) Int. Cl. F16L 25/00; E02D 5/38; E02D 5/44

(52) U.S. Cl. 405/237; 285/3

(57) ABSTRACT

A temporary casing is disclosed. The casing includes a primary portion capable of being driven into the ground and comprising a hollow portion wherein soil may be removed from within the primary casing portion, a detachable portion, also being capable of being driven into the ground and comprising a hollow portion wherein soil may be removed from within the detachable portion, a connection means for connecting the primary casing to the detachable portion such that the connection means enables the transfer of the driving force applied to the primary casing portion to the detachable portion in order to drive the detachable portion into the ground in association with the primary casing portion, wherein the connection means causes the detachable portion to detach from the primary portion when a threshold force is applied to the connection means and allows retrieval of at least the primary portion.

### CROSS-REFERENCE TO RELATED APPLICATIONS

This application claims the benefit of U.S. Provisional Application Ser. No. 61/160,178 filed on Mar. 13, 2009 and entitled BREAKAWAY CASING CONNECTION which application is incorporated by reference in its entirety.

### BACKGROUND OF THE INVENTION

1. The Field of the Invention

The present invention relates to a drilling casing. More particularly, embodiments of the invention relate to a temporary drilling casing with a detachable portion.

2. The Relevant Technology

Drilled shafts can be used to construct deep foundation units, which are capable of transferring loads from structures into deeper soil layers or to rock. Foundation units (also referred to herein as supports or columns) are typically constructed by drilling holes in the ground, placing steel reinforcement in the holes, and filling the holes with concrete.

Generally, hole sizes range from 2 feet in diameter to in excess of 13 feet in diameter. Hole size is determined from structure design loads and from the capacity of the soil or rock, which is provided by the friction on the sides of the shaft and from the end bearing capacity at the base of the shaft.

Drilled shafts in squeezing or caving soils (e.g., soft clay and sand) require the use of a steel pipe casing and/or drilling mud (e.g., slurry) to maintain the structure of the hole during drilling. Typically, the casing is driven, vibrated, or rotated into the ground to a depth beyond the caving or squeezing soils, at which point the casing is often driven or twisted a short distance into bedrock. As shown in FIG. 1, for example, the soil is removed from within the casing 30 by drilling using a kelly 10 and auger 20, which is capable of removing the soil from within the casing 30.

In most cases, the casing is not included in the structural design of the shaft and it is necessary only to keep the hole open during the drilling process until the reinforcing steel is placed in the hole and the hole is filled with concrete. Because the casing is not needed once the reinforcing steel and concrete fill the hole, it is preferable that the casing be pulled or removed from the hole so that it may be reused, if possible. Unfortunately, however, the casing often becomes stuck in the hole during the drilling and filling process and cannot be retrieved.

Depending on the specific size of the shaft needed for a project, the steel casing may be in excess of one-hundred feet in length, which represents a substantial investment, often in excess of $20,000 per casing. In addition to the lost expense in irretrievable materials, the presence of casing may also have an impact on the structural properties of the drilled shaft. For instance, the presence of casing may impact the side friction capacity between the drilled shaft and the surrounding soil since the load transfer in side friction is between soil and steel, which is relatively smooth, and may be less than the load transfer in side friction between soil and concrete, which is rougher.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a shaft drilling system currently used in the art;

FIG. 2 illustrates a temporary casing prior to placement in an environment;

FIG. 3 illustrates the temporary casing when placed in the environment of FIG. 2;

FIG. 4A illustrates the retrieval of a primary portion of the temporary casing illustrated in FIGS. 2-3;

FIG. 4B illustrates the retrieval of the primary portion in another environment where the detachable portion of the casing provides a form in a void in the environment;

FIGS. 5A-5E illustrate examples of a connection between a primary portion of a casing and a detachable portion of the casing;

FIGS. 6A-6B illustrate another example of a connection joining a primary casing portion with a detachable casing portion;

FIG. 7 illustrates another example of a connection between casing portion;

FIGS. 8A-8E illustrate a temporary casing that can be used to form a bell support or to form thinner supports in some environments;

FIG. 9 illustrates one embodiment of a method for retrieving a drill casing; and

FIG. 10 is a perspective view of a casing that includes multiple sections.

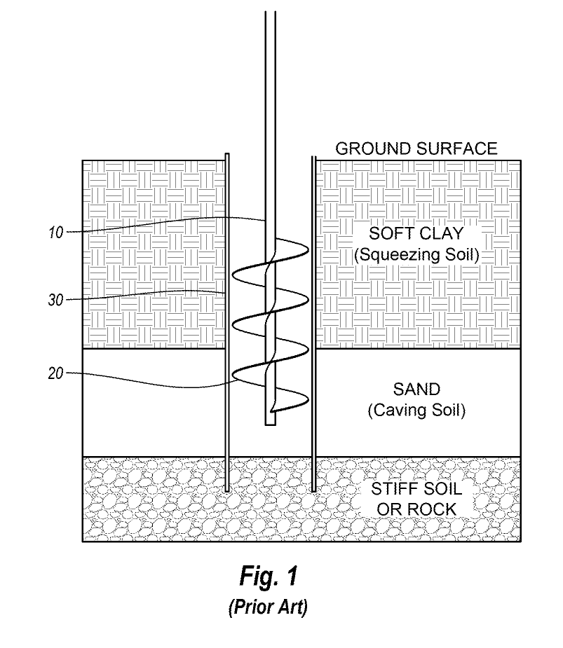

### DETAILED DESCRIPTION OF THE PREFERRED EMBODIMENTS

Embodiments of the invention relate generally to a temporary casing. Embodiments of the invention further relate to systems and methods for constructing a support including a bell support equivalent to a belled (underreamed) shaft. Embodiments of the invention further relate to systems and mechanisms for recovering at least a portion of the casing.

The temporary casing disclosed herein includes a detachable portion so that only the detachable portion of the casing, if any, is lost during the retrieval of the casing. The ability to reliably recover a substantial portion of the casing may result in significant savings since the casing may be reused for other applications including drilling additional shafts. Temporary casings that can be retrieved can reduce the material costs and delays associated with new casings each time a drilling shaft is needed. Furthermore, as described more fully below, embodiments of the present invention provides the ability to reduce these costs using a method and system that does not require additional equipment, tools, or extensive modifications to the systems that are currently in operation.

The casings disclosed herein are configured such that at least a portion of the casings can be retrieved. At the same time, the temporary casings disclosed herein can also be used as permanent casings where necessary (e.g., when required by government agency specifications or in instances where the project or construction may occur where there is no surrounding soil (e.g., water bodies, shafts that penetrate karstic features) to provide a form for the concrete support while the concrete cures). Even in these instances, some of the casing may be retrieved. For example, in an instance where the casing provides a form for the concrete in an environment where there is no surrounding soil (e.g., a void), the breakable connection may be placed above the void such that the portion of the casing above the void can be retrieved. Use of temporary casing can reduce the cost of shaft construction through material savings.

In some embodiments, the construction of a support, or drilled shaft, may use both conventional temporary casings and permanent casings. In one example, oversized temporary casing may be used to make the original hole. A permanent casing (usually corrugated metal pipe, (CMP) may be placed inside the temporary casing after the hole is complete. The support is then cast using the permanent casing as the form. The void between the casings may be filled with sand or other material if desired, and the temporary casing can be removed.

The advantage to this method is that it permits the use of a very thin permanent casing instead of heavier steel pipe because the thin permanent casing is placed in a pre-made hole and is not subjected to the stresses of driving during installation. Use of CMP for the permanent casing instead of heavier steel pipe can reduce the cost of permanent casing by as much as 75%. Unfortunately, the outer casing may become stuck and cannot be retrieved. Use of a casing with a detachable portion as described herein can increase the chances of recovering at least a portion of the temporary casing.

The casings disclosed herein when fabricated with the breakable connection also make it possible to more quickly protect degradable rock units than with conventional temporary casings. For situations where a combination of temporary and permanent casing is used, applicable specifications (or other reasons) may require the temporary casing not be removed for a period of time after the permanent casing is cast. The purpose of this delay is to give the support (shaft) time to gain strength as it cures to reduce the possibility of accidental damage to the shaft when the temporary casing is pulled.

If the rock that serves as the foundation material for the shaft is degradable when exposed (e.g, the rock may be exposed in the space between the two casings after drilling), the rock or foundation material may be protected by filling the space between the permanent casing and the temporary casing with cement grout or with another suitable material.

However, for conventional temporary casings, this grout cannot be placed until it is time to remove the temporary casing. Otherwise, the temporary and permanent casings will be cemented together. Use of a detachable casing tip will permit placement of the protective grout (e.g., one to two feet of grout in one embodiment) immediately after installation of the permanent casing because only the breakaway portion of the temporary casing will be cemented to the permanent casing. The primary portion of the temporary casing may be removed or retrieved. This can limit the time of exposure and limit the potential for degradation of the rock that is exposed, while limiting the potential for loss of the primary casing section.

The casings disclosed herein also will permit and facilitate use of smaller shaft sections above the load bearing unit (e.g., bell supports). Smaller shaft sections reduce costs. Shaft (support) design diameters are normally governed by soil and rock conditions, and are therefore larger than what is necessary to meet structural demands. Belled supports or shafts, which are shafts with a large diameter base to reduce the bearing pressure, have a relatively small column and thus save materials (concrete and steel) that may otherwise be used in the column. They can also provide enhanced resistance against uplift. Belled shafts are not often used today because the difficulties associated with constructing a bell outweigh the value of the materials saved over a conventional straight shaft in most cases.

Breakaway casings provide for a simpler and less expensive way to achieve the benefits of belled shafts. For example, the temporary casing is configured to have the desired large base diameter or, more generally, to have a base with a larger cross-sectional area compared to the column of the concrete shaft. A permanent thin-wall casing with the desired smaller shaft diameter will be used as a form for the column. This method permits a substantial savings in concrete and reinforcing steel in the column with limited additional effort beyond that required to construct a conventional straight shaft as described in more detail herein.

Generally, the temporary casings disclosed herein have a first portion and a second portion. The first portion is typically the portion that can be retrieved and is referred to herein as the primary portion. The second portion may or may not be retrieved and is referred to herein as a detachable portion or a detachable tip. The first portion is typically joined with the second portion before the temporary casing is placed in the ground. The connection is typically strong enough to withstand the forces that occur as the temporary casing is placed (e.g., driven, vibrated, and/or twisted) into the ground. Alternatively, the connection is typically strong enough such that the second portion does not detach before the process of placing the casing begins.

The first portion is also configured such that the connection enables the first portion to push against the detachable portion during placement. For example, the first portion may be configured to engage the detachable portion in a manner that enables the temporary casing to be placed in the ground by driving, vibrating, and/or rotating. The connection may be configured to enable forces to be transferred from the first portion to the second portion. The end of the first portion and the end of the detachable portion may have a male/female configuration for instance. The connection may enable the primary portion to engage the detachable portion in both lateral and axial directions.

The connection typically includes means for detaching the detachable portion from the primary portion. This can be achieved by including a shearable or breakable component. Often, the force required to place the temporary casing is not directed to the shearable or breakable component of the connection or is only partially directed to the shearable or breakable component. Rather, the shearable or breakable component is stressed during retrieval of the casing. When the connection breaks or shears, the primary portion only is retrieved. In other words, during retrieval of the primary portion, the connection is typically configured to break or shear at a predetermined threshold, thereby enabling retrieval of the first portion of the temporary casing. In some instances, this threshold may not be met and the detachable portion may also be retrieved.

The connection may also provide means for aligning the primary portion with the detachable portion. The alignment mechanism ensures that the detachable portion does not become displaced from the primary portion during placement of the temporary casing in the ground, thereby ensuring that the concrete support or column is properly formed.

The connection between the first portion and the second portion can be achieved using various attachment mechanisms. Bolts can be used to secure the first portion to the detachable portion. The bolts are typically spaced evenly about the casing and sized to break under a specific load. The total force required to break the connection is the number of bolts times the strength of an individual bolt. Control of this force may be gained by changing the number of bolts (not all holes need to have bolts) or changing the bolt size. Other attachment mechanisms, such as tabs and shear pins, may also be used.

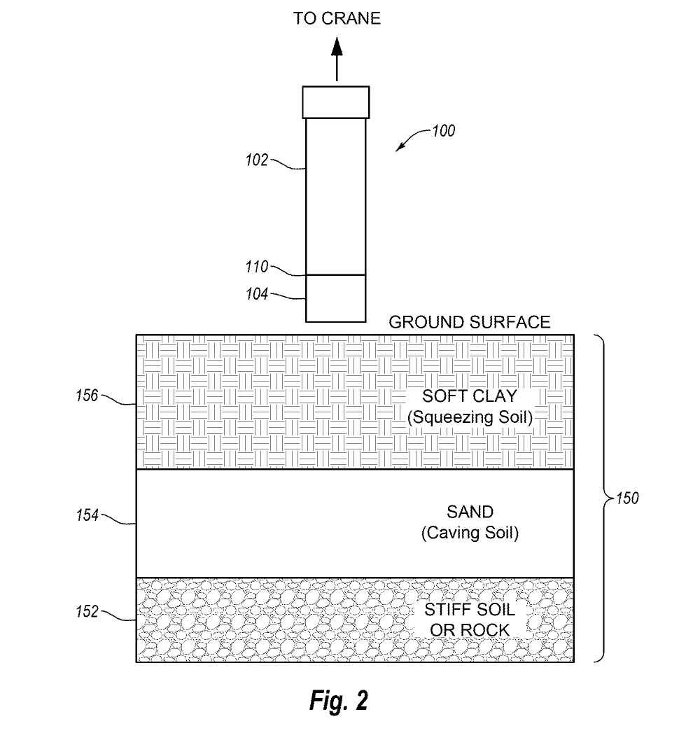

FIG. 2 illustrates an example of a temporary casing in the process of being placed in an environment. FIG. 2 illustrates a casing 100 that includes a first primary portion 102 and a second detachable portion 104. The portion 102 is joined to the detachable portion 104 by a connection 110. The detachable tip or portion 104 is attached to the base of the primary casing portion 102. The detachable portion 104 typically includes of a short section of pipe of the same or substantially the same size as the primary casing portion 102, and preferably is comprised of the same material.

The detachable portion 104 is connected to the portion 102 using a connecting mechanism or connection 110. The connection 110 may include a variety of connecting mechanisms, including but not limited to, two or more interlocking rings, a plurality of pins which are designed to shear when a threshold shear force is met, a plurality of screws, a plurality of bolts, an adhesive, a cable and latch connecting mechanism, or any combination thereof that is configured to detachably connect the primary portion 102 with the detachable portion 104.

The connection 110 is typically configured to ensure that the detachable portion 104 does not detach prior to placement in the environment 150. The bolts or other connecting mechanisms, for example, are selected such that weight of the detachable portion 104 does not cause the bolts (or other connecting mechanism) to shear or break. Once the placement of the casing 100 begins, however, the bolts or other connecting mechanism can be left in place or removed. If removed, the connection 110 can still ensure that the casing 100 is properly placed. Removing the connecting mechanism may assist in the retrieval process. When the connecting mechanism is removed, the detachable portion 104 will not be retrieved. When the connecting mechanism is not removed, it may be possible to retrieve the detachable portion 104.

As may be understood by one of ordinary skill in the art, the length of the detachable portion 104 may vary depending on the specific project. Embodiments are not limited to a specific length of detachable portion 104, however, and any variety of lengths may be used without departing from the scope of the claims below. In some instances, the length of the detachable portion 104 may depend on the environment in which the casing 100 is placed. Similarly, the length or configuration of the primary portion 102 can also vary for various reasons including the nature of the environment.

FIG. 2 further illustrates an example of an environment 150 in which a casing 100 may be placed. The environment 150, by way of example only, may include different types of soils, liquids, and/or voids. The environment 150, by way of example only, may include soft clay 156, sand 154, and stiff soil or rock 152. During placement of the casing 100 (e.g., by driving, vibration, and/or rotation), the casing 100 is forced into the ground through the various soils and often a short distance into the rock 152.

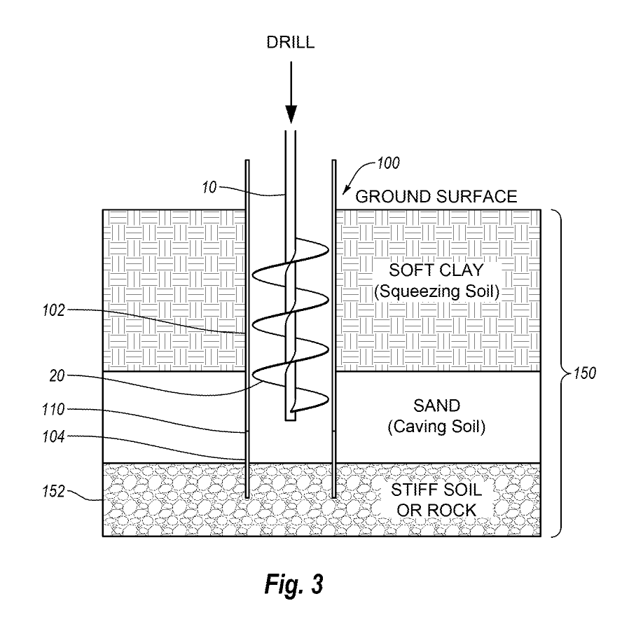

FIG. 3 illustrates the casing 100 after being positioned in the environment 150. The end of the detachable portion 104, in this example, has been driven into the rock 152. Once the casing 100 is positioned, an auger can be used to remove any soil and/or other material inside of the casing 100.

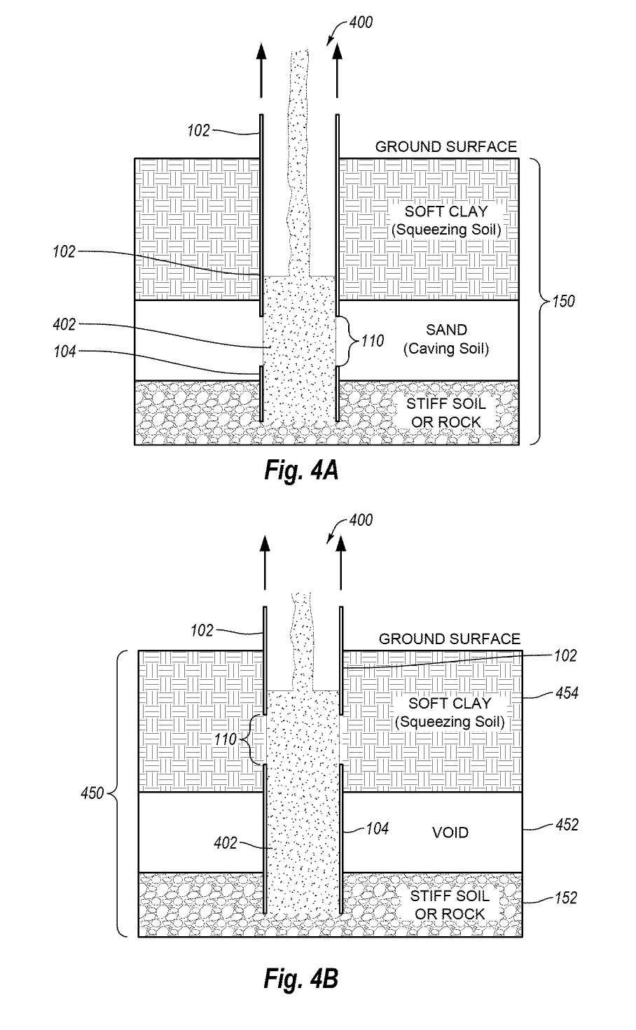

FIGS. 4A and 4B illustrate the casing 100 during extraction of the casing 100 from the ground. FIG. 4A illustrates that the support 400 is formed with concrete 402 and that the casing 100 provides a form for the concrete 402. In the example shown in FIG. 4A, the portion 102 (and the portion 104 in some instances) can be retrieved as the concrete 402 is poured, or some time after the concrete 402 has been poured. In one example, the portion 102 can be removed as the concrete 402 is poured because the soil provides a form for the concrete.

During retrieval of the casing 100, the connection 110 may break. FIG. 4A illustrates that the connection 110 has broken. As a result, the detachable portion 104 remains in the environment 150—embedded in the rock 152 in this example. The portion 102 can then be lifted out of the drilled shaft. Once removed, the portion 102 can be connected to another detachable portion and reused to form another support.

FIG. 4B illustrates an example where the environment 450 is different from the environment 150. In the environment 450, a void 452 exists (e.g, a cave, mine or other subsurface void) in the ground. The detachable portion 104 has a length that extends from the bedrock 152 to the soil 454 or to some point above the void 452. The detachable portion 104 maintains a form for the concrete 402 within the void 452.

When the casing 100 is extracted from the environment 450, the connection 110 breaks above the void 452. This ensures that the concrete 402 has the form defined by the detachable portion 104 while still permitting at least the portion 102 to be retrieved.

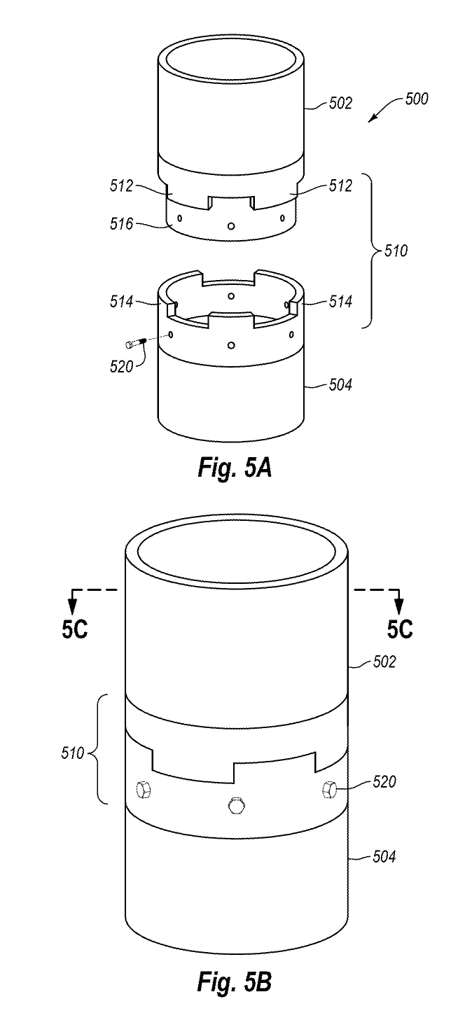

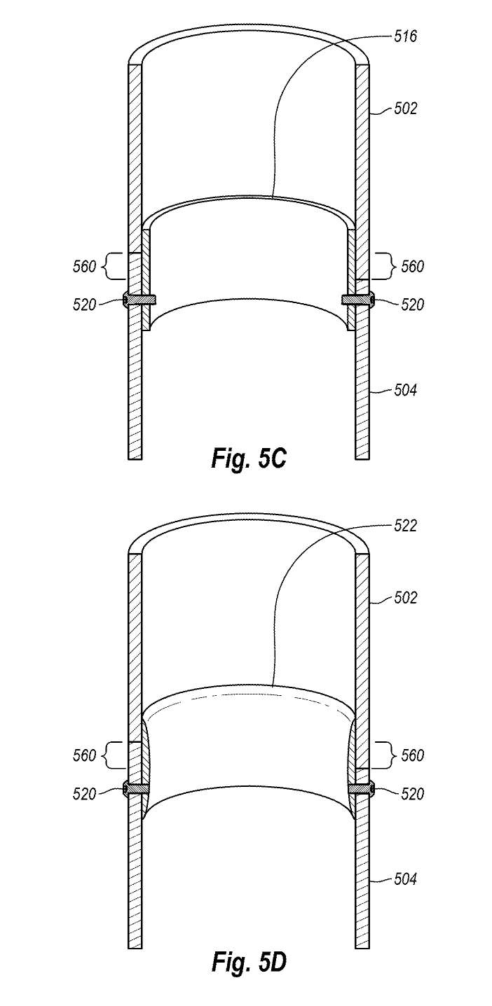

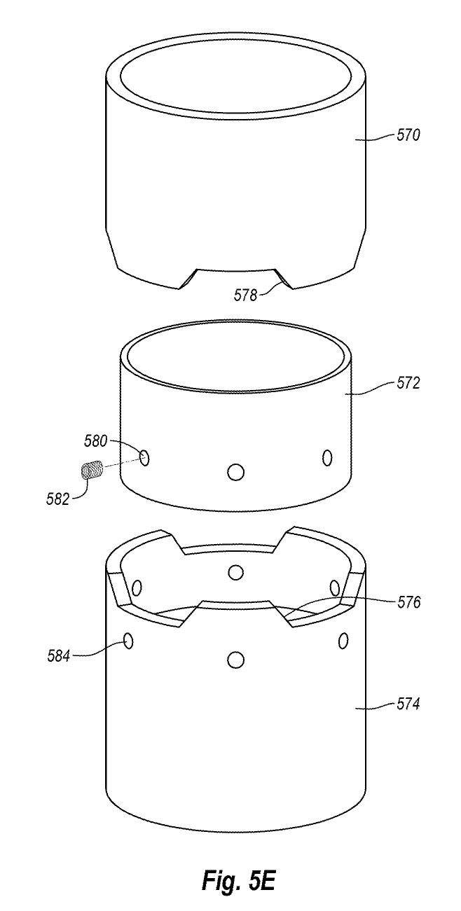

FIGS. 5A, 5B, and 5C illustrate a connection 510, which is an example of the connection 110. The connection 510 can join the portion 502 with the portion 504, which are examples of the portion 102 and 104, respectively. FIG. 5A illustrates the connection 510 before the portions 502 and 504 have been joined or after the connection 510 has been broken. FIG. 5B illustrates the connection 510 when the portions 502 and 504 are joined. FIG. 5C illustrates a cross section illustrating the connection 510 when the portions 502 and 504 are joined.

The connection 510 joins the portion 502 of the casing with the detachable portion 504. In this example, the end of the portion 502 includes teeth 512 that are configured to fit with corresponding teeth 514 on an end of the detachable portion 504. In this example, a sleeve 516 is permanently secured to the end of the portion 502, although it can be an integral part thereof. The sleeve 516 extends further than the teeth 512 and is capable of fitting with the interior diameter of the end of the detachable portion 504. Although FIG. 5A illustrates the sleeve 516 being on the interior of the portions 502 and 504, the sleeve 516 can also be configured to be on the outside of the portions 502 and 504. In this case, the diameter of the sleeve 516 would be larger than the diameter of the casing 500.

In this example, the teeth 512 and the teeth 514 engage such that when the casing 500 is twisted, both portions 502 and 504 twist at the same time. In other words, the end of the portion 502 can transfer force to the engaged end of the detachable portion 504. The teeth 512 are an example of an engagement mechanism and the teeth 514 are an example of complementary engagement mechanism that fit to enable placement of the casing 500 in an environment.

The joining ends of the portions 502 and 504 may be formed integral with the casing body. Alternatively, the ends (including the teeth and/or the sleeve) may be configured as rings that are attached to the ends of the portions 502 and 504.

In one example, the teeth 512 and 514 may be formed in the ends of the portions 502 and 504. Thus, the teeth 512 and 514 have the same or substantially the thickness as the rest of the casing. The sleeve 516, which can be located inside of the casing 500, may have a similar thickness as the wall of the casing 500. At the connection 510, the overall thickness may be about twice the thickness of the wall of the casing. The added thickness at the connection 510 does not typically interfere with an auger, which usually has a diameter that is less that the internal diameter of the casing. This ensures that the connection 510 does not interfere with the auger. In another example, the sleeve 516 may be sufficiently thin or beveled such that the interior surface of the casing 500 is sufficiently smooth to allow for drilling and/or formation of the concrete support. FIG. 5D, for example, illustrates an internal sleeve 522 that has beveled edges to provide a more smooth transition from the interior wall of the portions 502 and 504 to the sleeve 522.

When the portions 502 and 504 are joined, one or more bolts 520 (or other connecting mechanisms) can be inserted through the holes 518 in the portion 504 and the holes 522 in the sleeve 516. This configuration connects the portions 502 and 504 when the casing 500 is placed or positioned in the environment. The sleeve 516 can also ensure that the teeth 512 and 514 do not become displaced (e.g., laterally misaligned) during placement of the casing. The sleeve 516 may also align the portion 502 with the portion 504.

When the casing is extracted, the bolts 520 shear at or near a predetermined force and the portion 502 including the sleeve 516 is retrieved while the portion 504 remains as placed in the environment. The bolts 520 are often not subject to a shearing force during placement (although the bolts 520 are sufficiently strong to prevent detachment while the casing is positioned prior to placement in the ground) because the rings or ends of the primary portion and detachable portion are configured to bear the brunt of the placement forces.

The bolts 520 or other connecting mechanism, however, bear the force of retrieval. In other words, the walls of the portion 502 are aligned with the walls of the portion 504. As a result, the walls (including the teeth in one example) of the portion 502 push against the walls of the portion 504 when the casing 500 is driven or rotated. The bolts 520 may experience some of this force, but it is usually not sufficient to cause them to shear. In contrast, the majority of the force expended during retrieval is placed on the bolts. As a result, the bolts will shear when a predetermined force is exceeded and only the primary portion is retrieved.

The bolts 520 can be used to connect the portion 502 with the portion 504 in various ways. In one example, the holes in the sleeve 516 and or the detachable portion 504 may be tapped to receive the bolt. This ensures that no nut is required on the inside of the casing. An insert 580, such as illustrated in FIG. 5E, may also be used. In this case, the insert 580 is placed in a corresponding hole 578 formed in the sleeve 572. The insert 580 can be pressed in by force, twisted, or inserted in any other way known in the art. The bolt that can be passed through the hole 582 and secured to the insert 580. In a situation where the sleeve 572 is configured to be placed on the exterior of the casing, the insert may be placed in the hole 582. Examples of inserts include helical, thread-locking, self-tapping, knock-in, press-fit, mold-in, weld-in, and the like. The inserts, after the primary casing is retrieved, can be removed and replaced with a new insert, re-used where possible, or the like.

FIG. 5E also illustrates another example of teeth 576 and 578. In this example, the teeth 576 and 578 have sloped edges. The sides of the teeth are sloped in this example instead of vertical. Sloping the teeth 576 and 578 makes it easier to join the portion 502 with the portion 504 because perfect alignment is not needed initially. The teeth 576 and 578 still enable forces to be transferred from the portion 502 to the portion 504. The teeth 576 and 578 align themselves as the connection 510 is squeezed together. The slope can vary and can be quite close to vertical. For example, where a vertical angle is 90 degrees, the slope can be between 80 to 85 degrees, by way of example only. Other slopes are contemplated to be within the scope of the invention. The slope of each tooth or of each side of each tooth can be different. Further, the number of teeth in any given connection can vary.

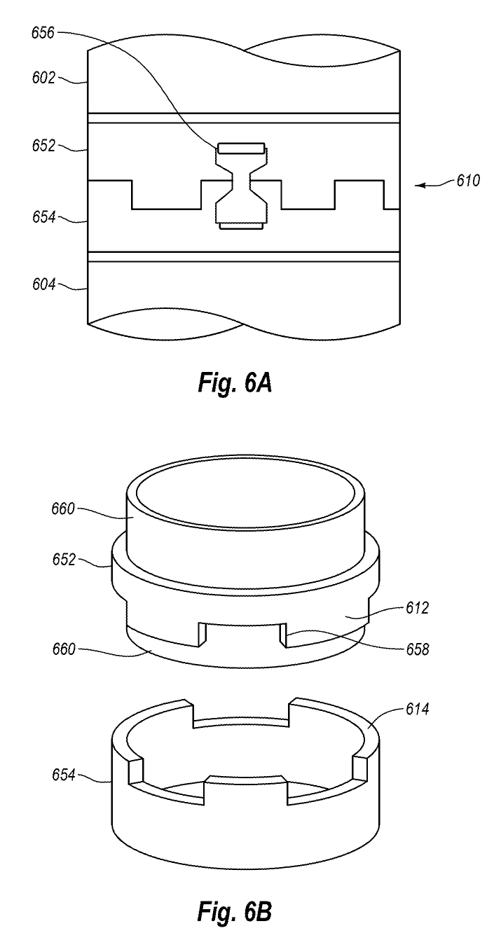

FIGS. 6A-6B illustrate another example of a breakable connection used in a casing. The connection 610, which is another example of the connection 110, is accomplished using a tab 656 that connects the end of the portion 602 (an example of the portion 102) to the end of the detachable portion 604 (an example of the portion 104).

FIG. 6A illustrates a ring 652 that is attached to an end of the portion 602. The ring 652 can be welded or otherwise attached. Similarly, a ring 654 is connected to an end of the detachable portion 604. More generally, the ends of the portions 102 and 104 (or other portions or embodiments disclosed herein) can be similarly attached to rings as discussed herein. For example, the teeth 512 and sleeve 516 may be embodied in a ring that is attached to an end of the 502.

Referring back to FIG. 6A, a ring 652 joins or mates with a corresponding ring 654. Thus, the rings 652 and 654 are configured with complementary structures that enable the rings to be joined in a manner that permits the casing to be placed in an environment.

Once the rings 652 and 654 are mated, the tab 656 can be welded or otherwise secured to the casing. More specifically, one end of the tab 656 is secured to the ring 652 and the other end of the tab 656 is secured to the ring 654. The number and/or size of tabs 656 used to join the portion 102 to the portion 104 can vary and may be selected according to a desired force at which the tabs shear or break.

The connection 610 (or the connection 110 or 510) can be a pair of interlocking rings, such as the ring 652 and 654. The ring 652 is welded or otherwise attached to the portion 102 of the casing while the ring 654 is welded or otherwise secured to the end of the detachable portion 104. Alternatively, the rings 652 and 654 (as well as the sleeve 660) may be an integral part of the portions 102 and 104.

As illustrated in FIG. 6B, the ring 652 may have an internal sleeve 660. The sleeve 660 may be extended through the top of the ring 652 to facilitate alignment and welding of the ring 652 to the portion 602. The sleeve 660 can align the ring 652 (now welded to the portion 602) with the ring 654 (now welded to the portion 604, or serving as the portion 604 itself) when the portions are joined as well as ensure that the portion 604 does not become displaced from the portion 602 when the casing is positioned in an environment. The teeth 612 and 614 are sized and configured to join such that the interior of the casing is substantially continuous when joined. In this example, the rings 652 and 654 do not significantly interfere with drilling or with concrete pouring or curing. The teeth 612 and 614, as well as other teeth configurations disclosed herein, can have any shape (e.g., triangular, square, etc.) and size.

As may be understood by one of ordinary skill in the art, the attachment process of joining the portions 102 and 104 may occur in a variety of environments, including in a manufacturing plant where the casing and/or interlocking rings are manufactured or at the site where the shaft is being constructed. In the embodiment shown in FIG. 6A-6B, the two rings 652 and 654 are connected by a plurality of steel tabs 656 that will yield at a predetermined tensile load. The rings 652 and 654 also have a configuration so as to interlock in order to maintain alignment between the primary casing 102 and detachable portion 104 and to transfer applied torque to the detachable portion 104 during the construction or drilling process.

The connection between the rings (e.g., the rings 652 and 654 or between rings in other connections including the connections 110 and 510) should be strong enough in tension for the detachable portion 104 to remain attached to the primary casing 102 when the primary casing 102 is lifted into position by a crane, as shown in FIG. 2. Then, as shown in FIG. 3, the casing 100 is installed using any number of methods currently used in the art, including driving, twisting, and/or vibrating the casing into place. As described more fully below, however, the connecting mechanism 110 is designed to break or be frangible if the uplift force that is exerted on the casing 102 and detachable portion 104 exceeds the connection strength of the connection 110.

In the embodiment shown in FIGS. 5A-5C, if the connection strength is overcome, the bolts 520 will break or shear and the primary portion 502 of the casing can be retrieved or recovered while the detachable portion 504 will be left in the ground. Similarly, the tabs 656 may break or detach when the connection strength is overcome.

For example, if the crane capacity is known to be too small to extract the full casing due to the weight of the casing combined with side friction on the casing in the drilled shaft, the breakable connection 110 may be set higher in the casing so that some fraction of the casing may be extracted. In instances where voids, such as caves, are present, the breakable connection may be set above the void elevation. This leaves a portion of the casing to serve as a form for the concrete where natural ground is not present. Even in this instance, a significant portion of the casing may still be extracted.

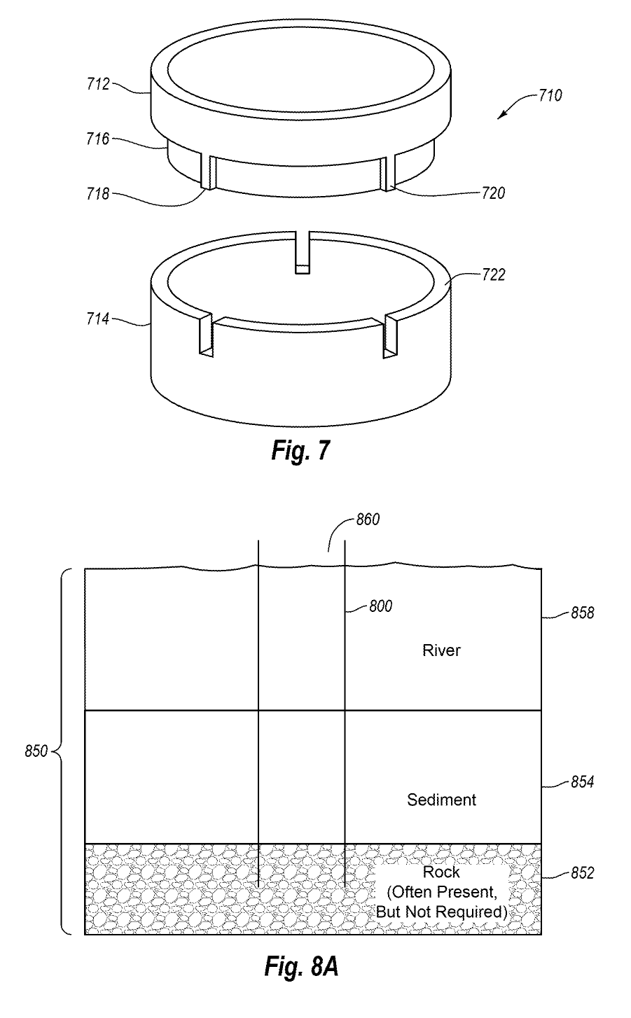

FIG. 7 illustrates another connection 710, which is another example of the connection 110. FIG. 7 includes rings 712 and 714. FIG. 7 illustrates teeth 720 and 722 that are of different sizes. While the teeth 612 and 614 and the teeth 512 and 514 are substantially the same size and shape, the teeth 720 and 722 have different dimensions. In this example, the teeth 720 and 722 represent a key and slot configuration. An internal guide sleeve 716 aligns the portions of the casing. The key and slot configuration allows torque to be applied to the casing. The rings 712 and 714 can be connected using tabs, bolts, or other mechanisms as described herein. Further, the teeth 720 and 722 may have sloped configurations as well to facilitate connecting the portions of the casing.

Thus, the present invention provides a temporary casing. The connection or attachment mechanism of the casing allows for severing a portion of the casing used in a drilled shaft, if necessary. This may be advantageous in situations where the end of the casing is stuck in stiff soil or rock. Using the methods and systems currently used in the art, such conditions would cause the entire casing to be irretrievable, whereas the embodiments described herein allow all but the entrenched or detachable portion to be removed. This may result in significant savings in construction costs and allow the retrieved portions of the casings to be reused.

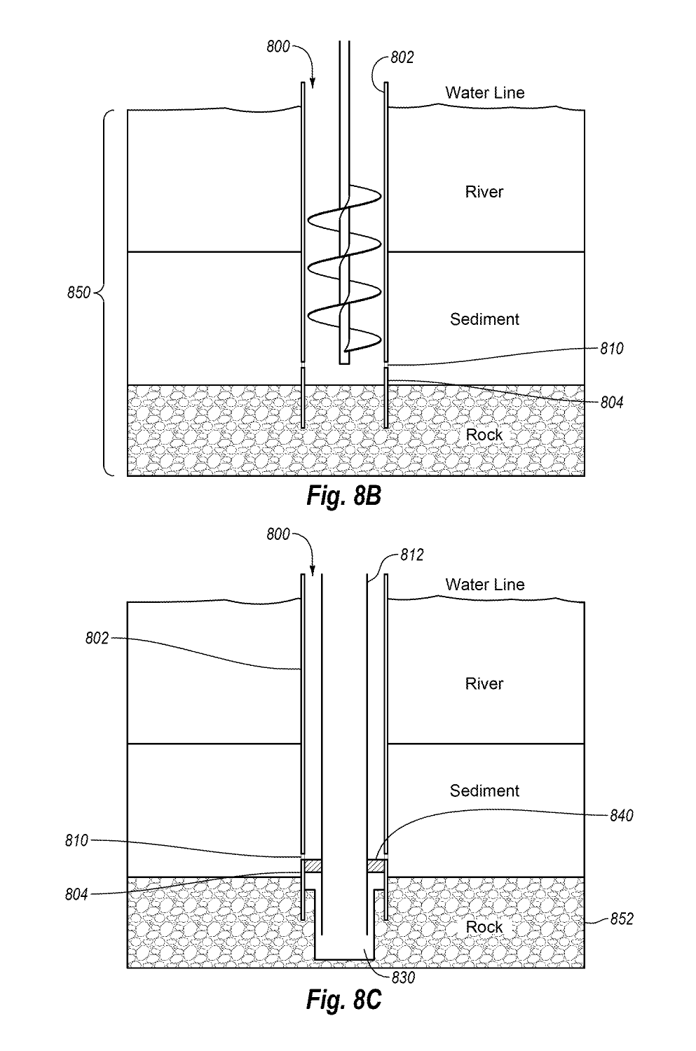

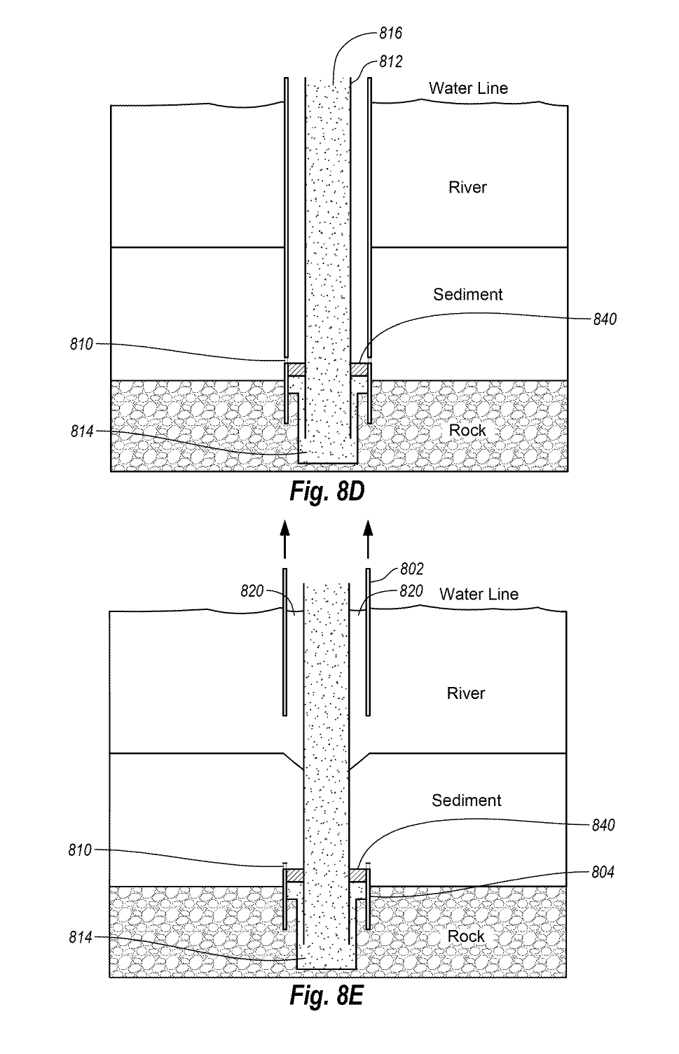

FIGS. 8A-8E illustrate temporary casings in another environment as well as the ability to form a bell support with a thinner column. FIG. 8A illustrates an environment 850 that includes water 858, sediment 854, and rock 852. FIG. 8A illustrates a temporary casing 800 that has been placed in the environment 850. At this point, the casing is filled with the natural soil 860 (water, sediment, and rock) because the soil 860 has not yet been augered out.

Drilled shafts constructed in water or in squeezing or caving soils require the use of casing, or steel pipe, to hold the hole open during drilling. FIG. 8B illustrates an example layout for a drilled shaft in an environment that includes water, although a similar layout can be used for other environments or to construct belled columns or supports. FIG. 8B illustrates the temporary casing 800. The casing 800 includes a primary portion 802 and a detachable portion 804 that are joined by a breakable connection 810. The casing 800 is placed in the environment 850 as described herein and any material inside the casing 800 is removed sufficiently to begin pouring concrete. As a result, the casing 800 provides a form that prevents the drilled shaft from filling with water or other material such as sand, clay, or the like.

FIG. 8C illustrates that a permanent casing 812 is placed inside of the casing 800. The casing 812 can be a very thin steel casing, but may also be composed of less expensive materials such as treated paperboard, or plastics such as PVC or HDPE. These materials could serve the purpose of a form for the concrete. Less expensive materials can be used for the casing 812 in part because the casing 812 is not usually subject to the forces exerted on the casing 800 during placement.

The temporary casing 800 is preferably steel and should be sufficiently thick to withstand the stresses of driving, vibrating, and/or rotating the casing 800 into the ground, particularly when rock is to be penetrated. The casing 800 can be in excess of one hundred feet in length for some projects, and represents a substantial investment, often in excess of $20,000 per pipe. For water projects, the casing normally has no function beyond serving as a form for the concrete until the concrete can set up and cure enough to support itself. After the concrete can support itself the casing could theoretically be removed, however the casing will bond to the concrete as it cures and the casing cannot be recovered. Thus, temporary casing with a breakaway connection may be used together with a less expensive form of permanent casing to reduce the overall cost of construction as illustrated in FIGS. 8D-8E.

As previously discussed, a steel casing 800 is used to advance the hole to a competent soil layer or into rock. The casing 800 may then be secured at the top to fix its position. A hole 830 of the design diameter is then drilled below the oversized casing 800 and into the foundation layer 852 to the design depth. This hole 830 may be drilled dry if the outer casing is strong enough to resist the hydrostatic head, or it may be drilled with water or slurry in the casing 800.

The permanent casing 812 (which may be ultra-thin walled casing, such as CMP) is then inserted into the casing 800 and into the hole 830. A seal/stop 840 may be used to seal the gap between the casing 812 and the outer casing 800 as shown in FIG. 8C. The seal 840 is typically placed below the breakable connection 810. The seal 840 may be composed of burlap, an inflatable tube, a steel ring, a geotextile, or other device or material to serve as a stop. The seal 840 may be covered with cement grout to seal the space between the casing 800 and the casing 812. In one example, the seal/stop 840 should have relief tubes to allow air and water to escape the rock socket (corresponding to the hole 830) as the hole 830 and the inner casing 812 are filled with concrete.

After the inner casing 812 is placed in the socket, reinforcing steel and concrete 816 may be placed in the inner casing 812. If concrete is able to flow around the bottom of the casing 812 and up between the casings 812 and 800, the optional seal/stop 840 (if used) will prevent the concrete from flowing up between the two casings 800 and 812 above the connection 810. This prevents the primary casing 802 above connection 810 from adhering to the concrete and enables the portion 802 to be retrieved.

FIG. 8D illustrates that a bell 814 (which may have any shape but typically has a greater cross sectional area than the concrete column formed by the casing 812) can be formed in this manner. The seal 840 can stop the flow of concrete while the bell 814 forms. In addition, the diameter of the support (corresponding to the interior diameter of the casing 812) is thinner that it would be if only a single casing were used. This saves costs in terms of reinforcing steel and concrete.

As illustrated in FIG. 8E, the casing 800 is pulled with a drill rig or other apparatus. The connection 810 breaks under tension and the casing portion 802 will be retrieved. In this case, the detachable portion 804 will be left in place as shown in FIG. 8E.

When an equivalent bell support (such as the bell 814 and support illustrated in FIG. 8E) is formed in a non-water environment, the area 820 between the casing 800 and the casing 812 can be backfilled with another material such as sand or flowable fill before, during, or after the portion 802 of the casing 800 is retrieved.

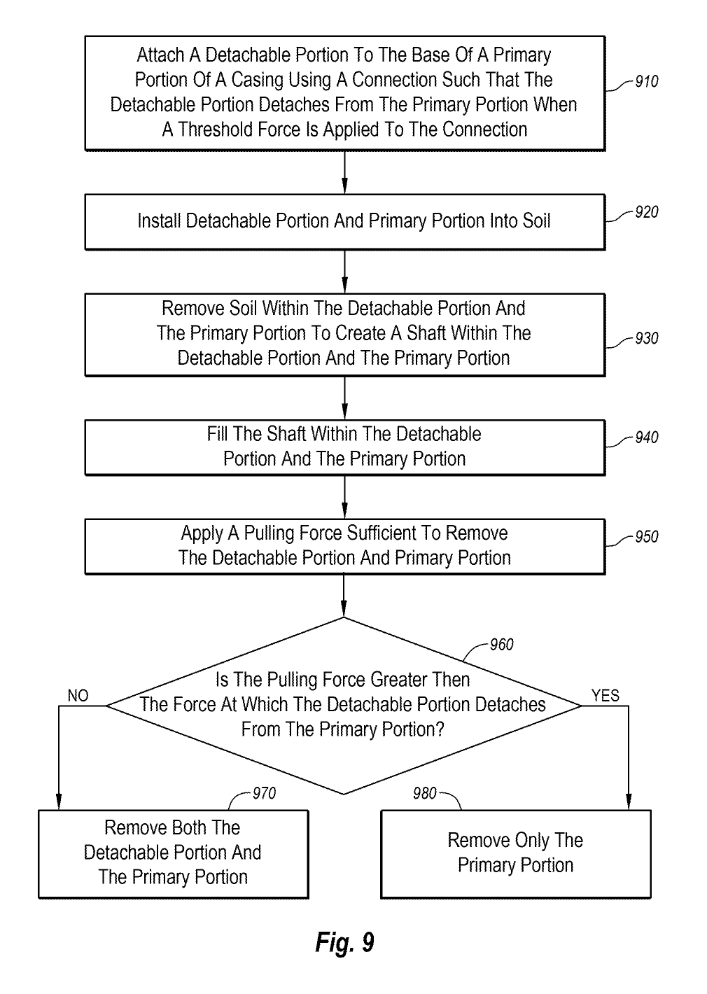

FIG. 9 illustrates a method of the present invention. The method is described using the connection mechanism such as the connection 110. As previously described, any number of connections may be used in association with the method described with reference to FIG. 9. In addition, the interlocking rings configuration is used for illustrative purposes only and is not intended to limit the scope or meaning of the method.

First, as previously described, a detachable portion of a casing is attached 910 to the base of the primary portion of the casing using a breakable connection or other connection mechanism. The connection is designed such that the detachable portion is detached from the primary portion when a threshold force is met.

In one embodiment, which uses the interlocking rings, this process includes welding one of the interlocking rings to the detachable portion and welding the other interlocking ring to the end of the primary portion of the casing. Then, the desired number of bolts or connection tabs with the desired yield strength are used to join the two rings. Preferably, the bolts or tabs are spaced evenly around the rings. In one example, not all of the holes for bolts need be used. The bolts are selected to resist a predetermined tensile force.

Then, the casing is installed 920 or positioned by driving, rotating, and/or vibrating it into place. Once the casing is positioned, soil is removed 930 from within the casing. As may be understood by one of skill in the art, the casing may be installed 920 at the same time that the soil is removed 930 from within the detachable portion and the primary portion.

Next, the shaft is filled 940 with concrete and, in some instances, reinforcing steel. If slurry is used during this process, the slurry is displaced out the top of the casing as normal. Next, a pulling force 950 is applied to the top of the casing. Typically, this begins as the concrete is being poured, preferably when the concrete is filled to a level that is 5 to 10 feet above the bottom of the portion 102, although this may also depend on where the breakable connection is located relative to the bottom of the casing. In this instance, however, since a detachable portion is used, the casing should not be pulled until the concrete is filled to a level that is 5 to 10 feet above the connecting mechanism between the primary casing and the detachable portion. If the pulling force does not exceed the strength of the connecting mechanism at step 960, both the primary portion and detachable portion may be recovered 970. If, however, the tension force required exceeds the strength of the connection joining the primary portion and the detachable portion, the connection will cause the primary portion of the casing to detach from the detachable portion. The primary portion of the casing is then pulled 980 for reuse.

As previously described, any number of connections may be used in association with the present invention. The particular connection may be selected based on the connection's specific properties. More specifically, the connection's properties under tension and shear must be considered. These are addressed separately.

One embodiment of the connection is a tension connection that holds the disposable detachable portion 104 to the primary portion 102. The connection 110 may be made in a number of ways, however, and can made using a steel member that is deliberately weakened, usually by a thinned section, such that it will fail under a predetermined load. Options include, but are not limited to, the embodiments described herein.

Tabs include short strips of steel with a thinned section designed to yield under a given load. Examples of how a thinned region may be created include, but are not limited to: cutting or punching the geometry of the original piece in order to remove or weaken the material, removal of material from a rectangular section, and cutting notches in a rectangular section while leaving a cross-section of a desired width.

Usually at least three tab connections are used. Tab size and thickness may be selected based on the desired tension at yield. As an example, a detachable portion 104 with a weight of 1000 pounds is attached to the primary portion 102. The detachable portion 104 is attached using three steel tabs consisting of 0.1 inch thick steel one inch in width with a combined cross-sectional area of 0.3 inches and an estimated yield strength of 15,000 lb. Actual yield strength may be somewhat higher or lower. For this case, the tabs are sufficiently strong to hold the detachable portion 104 to the primary casing 102 while the detachable portion 104 and primary casing 102 are moved into place above ground, and will make it possible for the detachable portion 104 to be recovered if the tensile force that the connection 110 is required to withstand is less than 15,000 lb. If the tensile force exceeds this amount, the tabs will break and only the primary portion 102 will be recovered. A set of three shear pin connections or bolt connections may also be used instead of the tab connections. In this embodiment, the pin connections are attached directly to the primary portion and detachable portion. Shear pins are used with a desired shear strength that is designed to withstand similar forces as the tabs. Bolts can also serve as a connection or attachment mechanism. As previously discussed, the bolts may shear at a predetermined force.

As described more fully below, one advantage of using the interconnecting rings is increased alignment and transfer of torque between the primary casing 102 and detachable portion 104.

As may be understood by one of ordinary skill in the art, the attachment mechanism of the connection 110 is disposed on the external surface of the primary portion 102 and detachable portion 104, but the connection 110 may also be disposed on the interior surface of the primary casing 102 and detachable portion 104. Bolts, for example, may pass through the bottom ring or through the detachable portion and into tapped holes in the sleeve or into inserts located in the sleeves.

As previously described, one benefit of using the interlocking rings or using another interlocking connection 110 is that it is possible to maintain the alignment between the primary casing 102 and disposable detachable portion 104. This is useful in order to adequately transfer the torque applied to the primary portion 102 to the detachable portion 104. This may be accomplished by fabricating a ring connection with interlocking teeth so that torque may be transferred and alignment may be maintained. The configuration may also include an inner sleeve attached to one of the interlocking rings in order to facilitate connection with the opposing interlocking ring. Thus, the sleeve is helpful in making the initial connection between the interlocking rings and in maintaining alignment during the driving process when the primary casing 102 and detachable portion 104 are driven into the ground.

This inner sleeve may be made of a section of pipe the same size as the rings or slightly smaller than the rings. The sleeve may have a small section removed after which one of the rings may then be compressed to a smaller diameter so that it will fit inside the opposing ring. The compression force may then be released, allowing the sleeve to expand tightly against the opposing ring. The sleeve may then be welded into place. The opposing ring may also include a beveled edge to promote the insertion of the upper ring into the lower ring during assembly.

In another of several alternatives, the casing interconnecting ring (on the primary portion) and tip interconnecting ring (attached to the detachable portion) may be machined such that a male-female connection between the two rings may be made. This would eliminate the need for a separate sleeve and result in a smooth inner bore that would prevent the drilling tools from catching on the steel sleeve. This configuration may also be achieved by machining a tip interconnecting ring in which notches are formed. Strips of steel may be welded onto the guide sleeve of a casing interconnecting ring which would act as gear teeth to transfer torque to the tip interconnecting ring.

In one configuration, tabs or bolts may be added to the connection. In an alternate configuration, however, no tabs may be used and the male-female connection may be used to transfer the torque and to properly align the primary casing portion and the detachable portion during the drilling process, after which only the primary portion would be removed since the pulling force applied to the casing would cause the male components of the casing interconnecting ring to disconnect from the female components of the tip interconnecting ring. This would cause the detachable portion to be disconnected such that the primary portion 102 may be removed while leaving the detachable portion 104 in the soil.

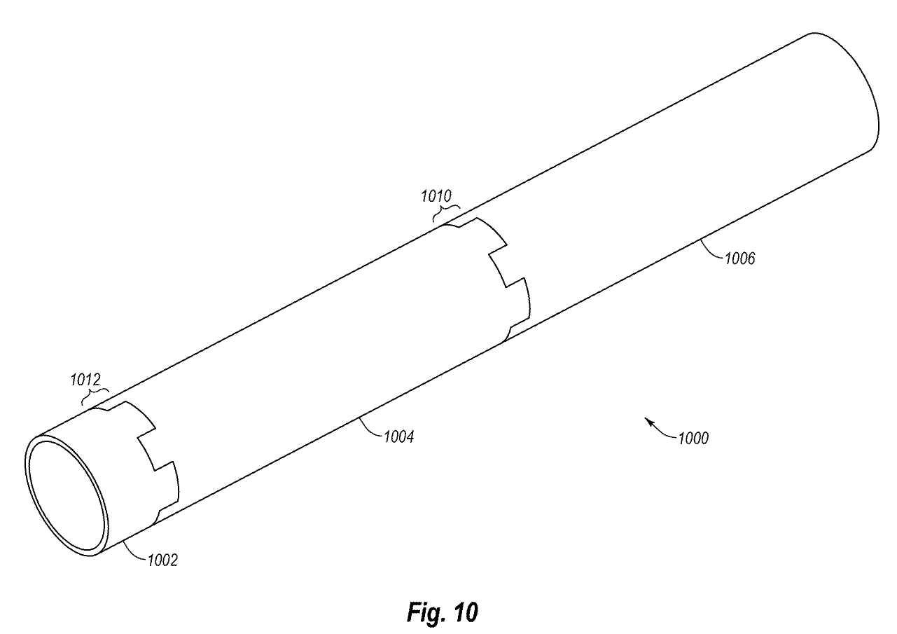

FIG. 10 illustrates another embodiment of the invention where the casing includes multiple sections. FIG. 10 illustrates a casing 1000 that includes a detachable portion 1002, and a primary portion 1004 (a first section), and a primary portion 1006 (a second section). The detachable portion 1002 joins the primary portion 1004 a connection 1012, which can be any of the connections or combinations of connection disclosed previously. Similarly, the connection 1010 joins the primary portion 1006 with the primary portion 1004.

A casing that is constructed from sections as shown by way of example only in FIG. 10 makes it possible to install casing in sections by setting one or more devices higher in the section. In other words, as the casing 1000 is positioned in an environment, the sections can be attached or joined as needed.

A sectioned casing 1000 can reduce transportation costs. Longer sections of casing are often welded together off site and transported to the project site. Sectioned casings can reduce transportation costs by making it possible to transport the casing to the site in sections. This reduces costs because transport of the individual sections (or multiple sections when permitted such as when stacked) can be done by conventional means with no special permits or escort vehicles required as it would be for overlength sections. The casing can then be bolted or otherwise joined together at the site and installed.

By installing a casing in sections, the drilling tool can get down inside the casing. Drilling equipment typically may have an operating height of 20 feet. By installing the casing in sections shorter than the maximum operating height, drilling tools can excavate soil from within the casing as it is installed, making installation easier in some cases. Additional sections can then be bolted on as the casing is processed into the ground.

A sectioned casing 1000 provides flexibility in point of breakage. By installing the casing in sections with a series of breakaway connection points (e.g., the connections 1012 and 1010), the sectioned casing 1000 can be connected such that the casing will break as the point closest to the maximum capacity of the crane. In other words, if sections are at 20, 40, and 60 feet deep, the number of bolts at each connection elevation could be installed such that all joints have some strength but the combination of that strength and the weight of the casing and side friction to that point will be less than the capacity of the crane. This way the maximum possible amount of casing can be retrieved based on the crane in use with the remainder left in the hole.

As previously described, the present invention provides a system and mechanism for detaching a portion of a casing used in the construction of a drilled shaft, so that a remaining portion of the casing may be recovered. Alternately, the present invention may be used in the construction of a water well or other construction including, but not limited to, gas, oil and/or geothermal applications. One advantage of the invention is that it may be performed using any number of configurations or other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A casing for use in constructing a drilled shaft that allows at least a portion of the casing to be retrieved from an environment, the casing comprising:
a primary portion, the primary casing portion having a first end;
a detachable portion, the detachable portion having a second end, wherein the first end of the primary portion is configured to fit with the second end of the detachable portion, wherein the first end and the second end are configured to transfer a driving force applied to the primary portion to the detachable portion; and
a breakable connection for joining the primary portion to the detachable portion, wherein the breakable connection causes the detachable portion to detach from the primary casing portion when a predetermined tensile force is applied to the breakable connection to allow retrieval of the primary portion from the environment.

2. The casing of claim 1, wherein the first end comprises a first ring having teeth and the second end comprises a second ring having teeth, the first ring attached to the primary portion and the second ring attached to the detachable portion.

3. The casing of claim 2, wherein the teeth of the first ring are shaped to fit with the teeth of the second ring and wherein the teeth of the first and second ring engage to transfer at least torque and compressive force from the primary portion to the detachable portion.

4. The casing of claim 3, further comprising an attachment mechanism that detachably secures the first ring to the second ring.

5. The casing of claim 4, wherein the attachment mechanism comprises bolts that are configured to shear at a predetermined force.

6. The casing of claim 4, wherein the attachment mechanism comprises tabs, a first end of the tabs attached to the first ring and a second end of the tabs attached to the second ring, the tabs located on an exterior surface of the first and second ring.

7. The casing of claim 5, further comprising a sleeve that is permanently attached to the primary portion, wherein the bolts pass through the detachable portion and are secured into one of tapped holes in the sleeve or inserts placed in the sleeve or nuts.

8. The casing of claim 1, wherein the breakable connection comprises:
a first ring attached to the first end of the primary portion, the first ring having a sleeve;
a second ring attached to the second end of the detachable portion, wherein the first ring and the second ring have complementary structure to join the primary portion with the detachable portion; and
an attachment means to secure the second ring to the sleeve, wherein the attachment means breaks when a threshold force is exceeded.

9. The casing of claim 8, wherein the attachment means comprises one of bolts or tabs.

10. The casing of claim 2, wherein the teeth of the first ring and the teeth of the second ring are sloped to facilitate joining the detachable portion and the primary portion.

11. The casing of claim 1, further comprising a second primary portion joined to the primary portion with a second breakable connection.

12. A temporary casing for constructing a drilled shaft, the casing comprising:
a primary portion having a first end;
a detachable portion having a second end;
a first ring permanently attached to the first end, the first ring having an engagement mechanism;
a second ring attached to the second end, wherein the second end includes a complementary engagement mechanism that fits with the engagement structure when the primary portion is joined with the detachable portion; and
an attachment mechanism connecting the first ring to the second ring, wherein the attachment mechanism is subject to a shear force during retrieval of the casing, wherein only the primary portion is retrieved when the shear force is exceeded and the attachment mechanism shears.

13. The temporary casing of claim 12, wherein the engagement mechanism and the complementary engagement mechanism fit to enable placement of the primary portion and the detachable portion in an environment.

14. The temporary casing of claim 12, wherein the engagement mechanism and the complementary engagement comprise teeth, wherein the first ring comprises an alignment mechanism to align the primary portion with the detachable portion.

15. The temporary casing of claim 12, wherein the attachment mechanism comprises bolts that secure the first ring to the second ring.

16. The temporary casing of claim 12, wherein an interior diameter of the temporary casing is substantially constant from the primary portion to the secondary portion and wherein the first and second rings do not interfere with drilling.

17. The temporary casing of claim 12, wherein the primary portion and the detachable portion comprise steel.

18. The temporary casing of claim 14, wherein the alignment mechanism comprises a sleeve permanently attached to the first ring, wherein the attachment mechanism passes through the second ring and attaches to the sleeve.

19. A method for constructing a bell support in an environment, the method comprising:
placing a temporary casing in an environment, the temporary casing having a primary portion and a detachable portion joined by a breakable connection, wherein material inside the temporary casing is extracted after the temporary casing is placed in the environment, wherein a diameter of the temporary casing determines a size of the bell support;
placing a permanent casing inside the temporary casing,
placing a seal between the permanent casing and the temporary casing below the breakable connection;
filling the permanent casing with at least concrete, wherein the concrete also fills a space below the seal to form the bell support; and
retrieving at least the primary portion of the temporary casing.

20. The method of claim 19, further comprising drilling a hole at a bottom of the drilled shaft to receive an end of the permanent casing, the hole and the seal defining a shape of the bell support.

21. The method of claim 19, further comprising placing cement grout on the seal.

22. The method of claim 19, further comprising retrieving the primary portion when the breakable connection breaks.
